(19) United States
(12) Patent Application Publication
(10) Pub. No.: US 2025/0175911 A1
(43) Pub. Date: May 29, 2025

(54) WIRELESS COMMUNICATION SYSTEM

(71) Applicant: FUJITSU LIMITED, Kawasaki-shi (JP)

(72) Inventor: Tetsuya HASEGAWA, Setagaya (JP)

(73) Assignee: FUJITSU LIMITED, Kawasaki-shi (JP)

(21) Appl. No.: 19/039,877

(22) Filed: Jan. 29, 2025

Related U.S. Application Data
(63) Continuation of application No. PCT/JP2022/031799, filed on Aug. 24, 2022.

(51) Int. Cl. H04W 52/54; H04W 72/044; H04W 72/1263; H04W 76/15

(52) U.S. Cl. CPC H04W 52/54; H04W 72/0473; H04W 72/1263; H04W 76/15

(57) ABSTRACT

A wireless communication system includes a first and a second wireless communication devices, wherein the first wireless communication device transmits an information signal and an energy signal and controls transmission of the information signal and the energy signal, the second wireless communication device branches a received signal from the first wireless communication device, generates a first received signal and a second received signal, rectifies the energy signal included in the first received signal and generates a direct current, decodes the information signal included in the second received signal, and generates control information that includes a request related to transmission power of the information signal and the energy signal, the second wireless communication device transmits the control information to the first wireless communication device, and the first wireless communication device controls the transmission power of the information signal and the energy signal based on the control information.

### CROSS-REFERENCE TO RELATED APPLICATION

This application is a continuation application of International Application PCT/JP2022/031799 filed on Aug. 24, 2022 and designated the U.S., the entire contents of which are incorporated herein by reference.

### FIELD

The embodiments discussed herein are related to a wireless communication system that can perform wireless power supply.

### BACKGROUND

In recent years, wireless power supply for transmitting power to a wireless communication device using electromagnetic waves has been studied. For example, in a mobile communication system, power is transmitted from a base station to a terminal device using the electromagnetic waves. In this case, the base station simultaneously transmits an information signal and an energy signal to the terminal device. The terminal device decodes the information signal to acquire information and rectifies the energy signal to charge a battery.

FIG. 1 illustrates an example of a wireless communication system that can perform wireless power supply. In a wireless communication system 100, as illustrated in FIG. 1, the information signal and the energy signal are simultaneously transmitted from a base station 1 to a terminal device 3. Here, the terminal device 3 includes a splitter 3a, an energy receiver (Energy Receiver) 3b, and an information receiver (Information Receiver) 3c. The splitter 3a branches the signal received from the base station 1 at a predetermined ratio and guides the signal to the energy receiver 3b and the information receiver 3c.

The energy receiver 3b generates a direct current by rectifying the energy signal in a received signal. Then, the battery is charged by this direct current. After down-converting the received signal, the information receiver 3c reproduces the information by decoding the information signal.

Note that a method for simultaneously transmitting the information and the power is, for example, described in X. Zhou, R. Zhang, and C. K. Ho, Wireless information and power Transfer: Architecture design and rate-energy tradeoff, IEEE Transactions on Communications, Vol. 61, No. 11, pp. 4754 to 4767 November 2013, and Overview on 5G Radio Frequency Energy Harvesting https://www.astesj.com/publications/ASTESJ_040442.pdf. Furthermore, a wireless communication system that can perform power transmission is described in Japanese Laid-open Patent Publication No. 2021-035257 and Japanese Laid-open Patent Publication No. 2011-193707.

Japanese Laid-open Patent Publication No. 2021-035257, Japanese Laid-Open Patent Publication No. 2011-193707, X. Zhou, R. Zhang, and C. K. Ho, Wireless information and power Transfer: Architecture design and rate-energy tradeoff, IEEE Transactions on Communications, Vol. 61, No. 11, pp. 4754 to 4767 November 2013, and Overview on 5G Radio Frequency Energy Harvesting https://www.astesj.com/publications/ASTESJ_040442.pdf are disclosed as related arts.

### SUMMARY

According to an aspect of the embodiments, a wireless communication system includes a first wireless communication device; and a second wireless communication device, wherein the first wireless communication device includes a transmission circuit that transmits an information signal and an energy signal, and a first processor that controls transmission of the information signal and the energy signal, the second wireless communication device includes a splitter that branches a received signal from the first wireless communication device and generates a first received signal and a second received signal, an energy receiver that rectifies the energy signal included in the first received signal and generates a direct current, an information receiver that decodes the information signal included in the second received signal, and a second processor that generates control information that includes a request related to transmission power of the information signal and transmission power of the energy signal, the second wireless communication device transmits the control information to the first wireless communication device, and in the first wireless communication device, the first processor controls the transmission power of the information signal and the transmission power of the energy signal based on the control information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a wireless communication system that can perform wireless power supply;

FIG. 2 is a diagram illustrating an example of a power supply sequence of the wireless communication system according to a first embodiment;

FIGS. 3A and 3B are diagrams illustrating an example of an operation of a terminal device in the power supply sequence illustrated in FIG. 2;

FIG. 4 is a diagram illustrating an example of a base station according to a second embodiment;

FIG. 5 is a diagram illustrating an example of a signal transmitted from the base station to the terminal device;

FIG. 6 is a diagram illustrating an example of a terminal device according to the second embodiment;

FIGS. 7A to 7D are diagrams for explaining distribution of power in the second embodiment;

FIG. 8 is a diagram illustrating an example of a power supply sequence according to the second embodiment;

FIG. 9 is a diagram (part 1) illustrating a relationship between a distribution rate of a splitter and transmission power;

FIG. 10 is a diagram (part 2) illustrating the relationship between the distribution rate of the splitter and the transmission power;

FIG. 11 is a diagram illustrating a first variation of the second embodiment;

FIG. 12 is a diagram illustrating a second variation of the second embodiment;

FIGS. 13A and 13B are diagrams illustrating a third variation of the second embodiment;

FIG. 14 is a diagram illustrating a fourth variation of the second embodiment; and

FIG. 15 is a diagram illustrating an example of a frame for transmitting an information signal and an energy signal by time division multiplexing.

### DESCRIPTION OF EMBODIMENTS

In the wireless communication system described above, when the battery of the terminal device 3 is sufficiently charged, the terminal device 3 does not need to receive the energy signal. On the other hand, when a charge amount of the battery of the terminal device 3 is not sufficient, it is preferable for the terminal device 3 that power of the energy signal is large.

However, in an existing wireless communication system that simultaneously transmits an information signal and an energy signal, a ratio between power of the information signal and power of the energy signal is determined in advance. Therefore, a trade-off occurs between a transmission rate of information and an efficiency of wireless power supply.

### First Embodiment

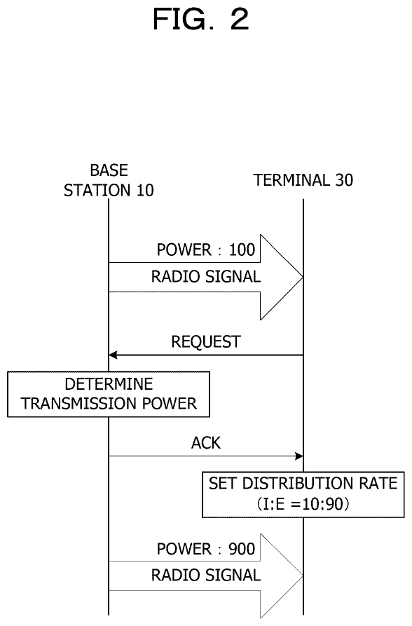

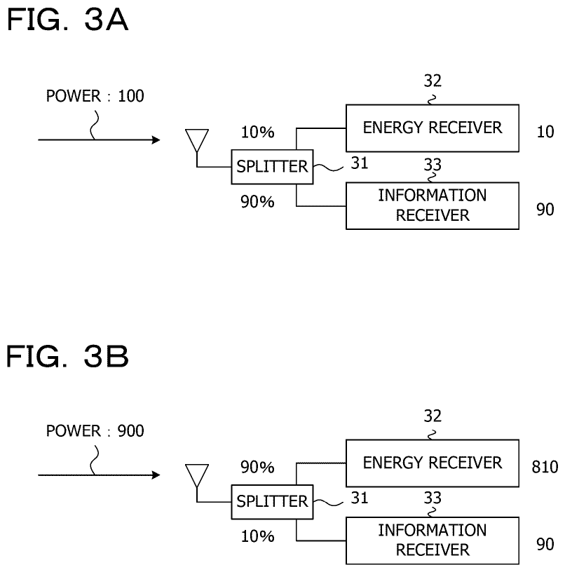

FIG. 2 illustrates an example of a power supply sequence of a wireless communication system according to a first embodiment. FIGS. 3A and 3B illustrate examples of an operation of a terminal device in the power supply sequence illustrated in FIG. 2. Note that, in the examples illustrated in FIGS. 2 and 3A and 3B, a radio signal is transmitted from a base station 10 to a terminal device 30. At this time, it is assumed that power of the radio signal be “100”.

As illustrated in FIGS. 3A and 3B, the terminal device 30 includes a splitter 31 and branches the received signal and guides the signal to an energy receiver 32 and an information receiver 33. In the example illustrated in FIG. 3A, a ratio between power of the signal guided to the energy receiver 32 and power of the signal guided to the information receiver 33 is “10:90”. In this case, the power of the signal guided to the energy receiver 32 is “10”. The energy receiver 32 charges a battery using this power. Furthermore, the power of the signal guided to the information receiver 33 is “90”. The information receiver 33 decodes this signal and reproduces information. Note that, here, numerical values indicating transmission power and reception power are virtual values for simplification of the description, and in addition, it is assumed that there be no attenuation between the base station 10 and the terminal device 30.

When a charging rate of the battery of the terminal device 30 is low, the terminal device 30 increases a ratio of power to be distributed to the energy receiver 32, with respect to power to be distributed to the information receiver 33. In this example, the ratio between the power to be distributed to the energy receiver 32 and the power to be distributed to the information receiver 33 is changed to “90:10”. However, if a distribution rate of the splitter 31 is changed in a state where the power of the radio signal transmitted from the base station 10 is fixed, the power of the signal guided to the information receiver 33 decreases. In this case, since an error rate increases due to deterioration in a signal-to-noise ratio, there is a possibility that a transmission rate is lowered.

Therefore, when the distribution rate of the splitter 31 is changed, it is preferable to change the power of the radio signal transmitted from the base station 10. For example, when the distribution rate of the splitter 31 is changed, it is preferable to increase the power of the radio signal transmitted from the base station 10, so as to maintain the power of the signal guided to the information receiver 33. In this case, the battery can be efficiently charged, without lowering the transmission rate of the wireless communication.

Therefore, when changing the distribution rate of the splitter 31, the terminal device 30 transmits, to the base station 10, a request for increasing the transmission power, so as to maintain the power of the signal guided to the information receiver 33. In the examples illustrated in FIGS. 2 and 3A and 3B, when the ratio between the power to be distributed to the energy receiver 32 and the power to be distributed to the information receiver 33 is “90:10”, the power of the radio signal needs to be “900”, in order to set the power of the signal guided to the information receiver 33 to “90”. Therefore, the terminal device 30 transmits a request for setting the power of the radio signal to “900” to the base station 10.

When the base station 10 can control transmission power in response to this request, the base station 10 transmits an ACK signal to the terminal device 30. When receiving the ACK signal, the terminal device 30 sets the distribution rate of the splitter 31 so that the ratio between the power to be distributed to the energy receiver 32 and the power to be distributed to the information receiver 33 is “90:10”. Thereafter, the base station 10 increases the transmission power of the radio signal from “100” to “900”. Then, as illustrated in FIG. 3B, the power of the signal guided to the energy receiver 32 is “810”. Then, the energy receiver 32 charges the battery using this power. Therefore, it is possible to efficiently charge the battery using large power. Furthermore, the power of the signal guided to the information receiver 33 is maintained to be “90”. For example, even if the distribution rate of the splitter 31 is changed, the power of the signal guided to the information receiver 33 does not change. Therefore, the transmission rate is not lowered.

### Second Embodiment

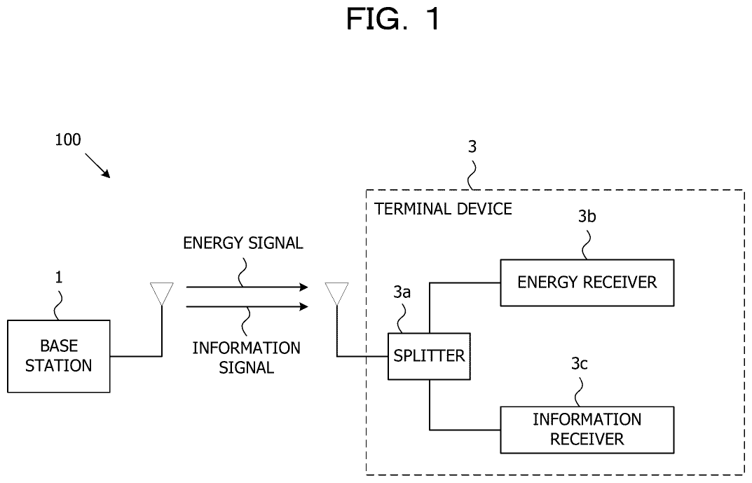

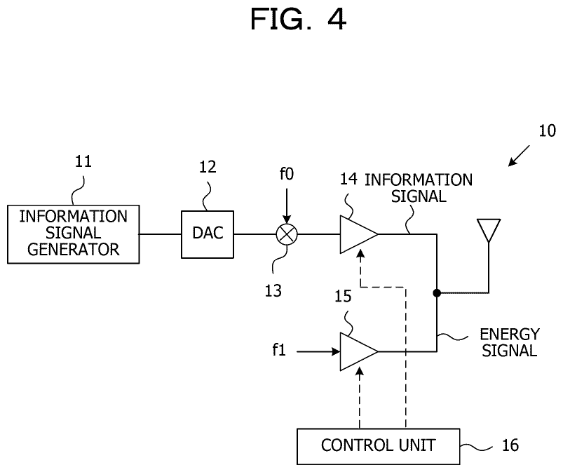

FIG. 4 illustrates an example of a base station according to a second embodiment. Note that, a base station 10 illustrated in FIG. 4 corresponds to the base station 1 illustrated in FIG. 1. For example, the base station 10 can simultaneously transmit an information signal and an energy signal to a terminal device. The information signal and the energy signal are not particularly limited. However, the information signal and the energy signal are transmitted on carrier waves o frequencies different from each other, in this example. For example, the information signal and the energy signal are simultaneously transmitted by frequency division multiplexing.

The base station 10 includes an information signal generator 11, a digital/analog converter (DAC) 12, a mixer 13, an amplifier 14, an amplifier 15, and a control unit 16. However, in FIG. 4, only components used to transmit a signal to the terminal device are illustrated. For example, the base station 10 may include other circuits or functions not illustrated in FIG. 4.

The information signal generator 11 generates the information signal including data and control information to be received by the terminal device. The information signal generator 11 is, for example, implemented by a digital signal processor (DSP). The DAC 12 converts the information signal generated by the information signal generator 11 into an analog signal. The mixer 13 up-converts an output signal of the DAC 12 using a carrier frequency signal f0. For example, the carrier frequency signal f0 is modulated by the information signal. The amplifier 14 amplifies an output signal of the mixer 13. A gain of the amplifier 14 is controlled by the control unit 16. Note that, in the following description, an output signal of the amplifier 14 may be referred to as an “information signal”.

The amplifier 15 amplifies a carrier frequency signal f1. Although the carrier frequency signal f1 is not modulated in the example illustrated in FIG. 4, the carrier frequency signal f1 may be modulated by a pseudo signal or a dummy signal. A gain of the amplifier 15 is also controlled by the control unit 16. Note that, in the following description, an output signal of the amplifier 15 may be referred to as an “energy signal”.

The control unit 16 controls an operation of the base station 10. For example, the control unit 16 controls communication between the base station 10 and the terminal device. However, hereinafter, control related to transmission of the information signal and the energy signal will be described.

The control unit 16 determines transmission power of the information signal and transmission power of the energy signal. At this time, the control unit 16 may determine a ratio between the transmission power of the information signal and the transmission power of the energy signal. Here, the control unit 16 may determine the ratio between the transmission power of the information signal and the transmission power of the energy signal, in response to a request from the terminal device. However, the control unit 16 can determine the ratio between the transmission power of the information signal and the transmission power of the energy signal, without receiving the request from the terminal device. Then, the control unit 16 controls each of the transmission power of the information signal and the transmission power of the energy signal, based on the determined ratio. Note that the control unit 16 controls each of the transmission power of the information signal and the transmission power of the energy signal, by controlling the gains of the amplifiers 14 and 15.

For example, the control unit 16 is implemented by a processor. For example, the processor may control the transmission power of the information signal and the energy signal by executing a software program. Alternatively, the processor (for example, control unit 34) may be implemented by a hardware circuit that processes a digital signal.

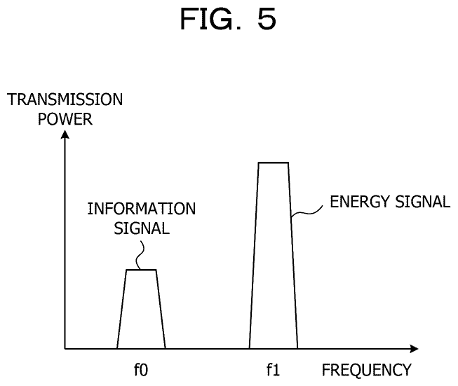

FIG. 5 illustrates an example of a signal transmitted from the base station 10 to the terminal device. In this example, the base station 10 transmits the information signal and the energy signal to the terminal device. A carrier frequency of the information signal is f0, and a carrier frequency of the energy signal is f1. Furthermore, the base station 10 can individually control the transmission power of the information signal and the transmission power of the energy signal. In this example, the transmission power of the energy signal is larger than the transmission power of the information signal. Note that the base station 10 controls the transmission power of each signal so that total transmission power (for example, sum of transmission power of information signal and transmission power of energy signal) is equal to or less than predetermined maximum power. Furthermore, the base station 10 may control the transmission power of the information signal according to a communication environment between the base station 10 and the terminal device. Moreover, as will be described later, the base station 10 may determine the ratio between the transmission power of the information signal and the transmission power of the energy signal, in response to the request from the terminal device.

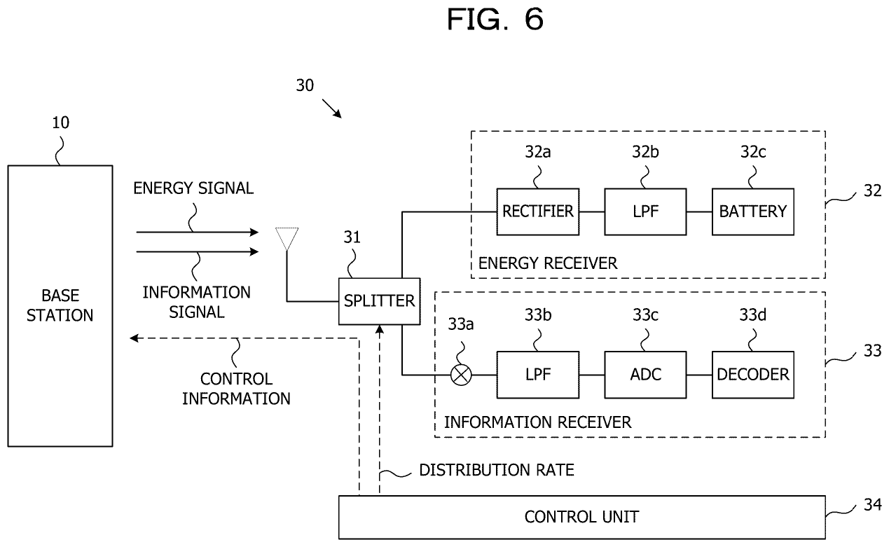

FIG. 6 illustrates an example of the terminal device according to the second embodiment. Note that a terminal device 30 illustrated in FIG. 6 corresponds to the terminal device 3 illustrated in FIG. 1. For example, the terminal device 30 can simultaneously receive the information signal and the energy signal.

Here, the terminal device 30 includes a splitter 31, an energy receiver (Energy Receiver) 32, an information receiver (Information Receiver) 33, and a control unit 34. Note that the terminal device 30 may include other circuits or functions not illustrated in FIG. 6. For example, although not illustrated, the terminal device 30 includes a transmitter that transmits a signal to the base station 10.

The splitter 31 branches the signal received from the base station 10 at a predetermined ratio and guides the signal to the energy receiver 32 and the information receiver 33. In the following description, the ratio between the power of the signal guided to the energy receiver 32 and the power of the signal guided to the information receiver 33 may be referred to as a “distribution rate”. A distribution rate of the splitter 31 is controlled by the control unit 34. For example, when a distribution rate instructed by the control unit 34 is “X (percent)”, the power of the signal guided to the energy receiver 32 is “X” percents of total power of the signal received by the terminal device 30, and the power of the signal guided to the information receiver 33 is “100−X” percents of the total power of the signal received by the terminal device 30. The distribution rate of the splitter 31 is set, for example, by controlling each of a resistance value of a path between an input port and the energy receiver 32 and a resistance value of a path between the input port and the information receiver 33.

The energy receiver 32 includes a rectifier circuit 32a, a low pass filter (LPF) 32b, and a battery 32c. The rectifier circuit 32a includes a single or a plurality of diodes and rectifies a received signal. The LPF 32b filters an output signal of the rectifier circuit 32a. As a result, the direct current is generated. Then, the battery 32c is charged by this direct current. Note that, it is assumed that, when the terminal device 30 receives the energy signal and the information signal, the energy receiver 32 charge the battery 32c using the power of the energy signal. For example, when the information signal and the energy signal are simultaneously transmitted by frequency division multiplexing, the direct current may be generated by rectifying a frequency component of the energy signal.

The information receiver 33 includes a mixer 33a, a low pass filter (LPF) 33b, an analog/digital converter (ADC) 33c, and a decoder 33d. The mixer 33a performs down-conversion by multiplying the received signal by the carrier frequency signal f0. As a result, the information signal is converted from a carrier frequency domain to a baseband domain. The LPF 33b filters an output signal of the mixer 33a. As a result, noise components and unnecessary high frequency components are removed. The ADC 33c converts an output signal of the LPF 33b into a digital signal. The decoder 33d decodes the digital signal output from the ADC 33c and reproduces information. Note that, when the information signal transmitted from the base station 10 includes the control information, control information reproduced by the decoder 33d is sent to the control unit 34.

The control unit 34 controls an operation of the terminal device 30. For example, the control unit 34 controls communication between the base station 10 and the terminal device 30. However, hereinafter, control related to reception of the information signal and the energy signal will be described.

The control unit 34 can monitor a charge state of the battery 32c. The charge state of the battery 32c is detected, for example, based on a voltage of the battery 32c. Furthermore, the control unit 34 monitors a communication state between the base station 10 and the terminal device 30. The communication state may be detected, for example, based on an error rate of an output signal of the decoder 33d. Then, the control unit 34 generates the control information including the request regarding the transmission power of the information signal and the transmission power of the energy signal, based on these monitoring results. For example, the control information includes information indicating the ratio between the transmission power of the information signal and the transmission power of the energy signal. Alternatively, the control information may include information indicating a desired value of the transmission power of the information signal and a desired value of the transmission power of the energy signal. Then, the control unit 34 transmits the generated control information to the base station 10. Then, the base station 10 controls the transmission power of the information signal and the transmission power of the energy signal, according to the control information received from the terminal device 30. In addition, the control unit 34 may control the distribution rate of the splitter 31, based on the monitoring result.

For example, the control unit 34 is implemented by a processor. For example, the processor may generate the control information and control the splitter 31, by executing a software program. Alternatively, the processor (for example, control unit 34) may be implemented by a hardware circuit that processes a digital signal.

In this way, the base station 10 controls the transmission power of the information signal and the transmission power of the energy signal, according to the control information received from the terminal device 30. Therefore, power used to charge the battery 32c and power used for the wireless communication depend on not only the distribution rate of the splitter 31 but also the ratio between the transmission power of the information signal and the transmission power of the energy signal.

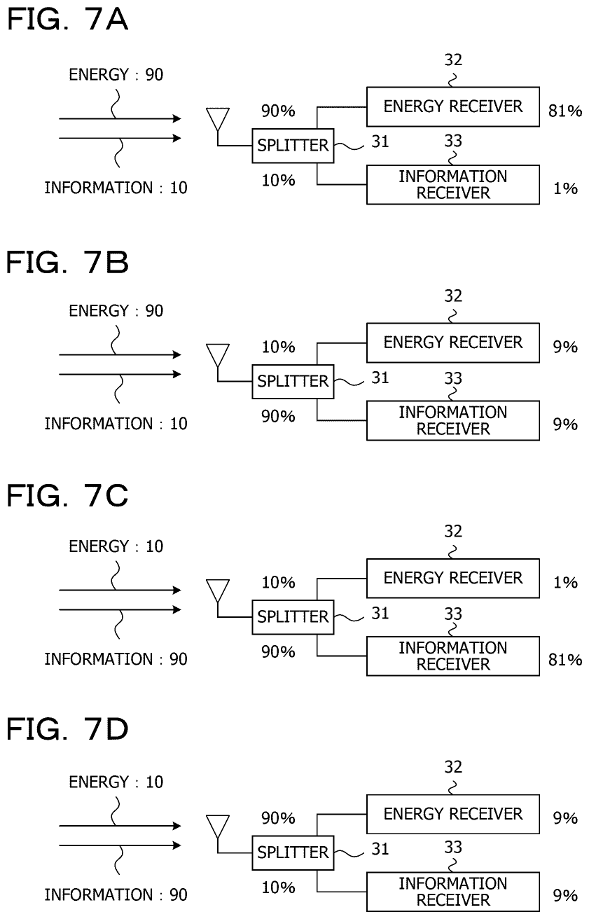

FIGS. 7A to 7D are diagrams for explaining distribution of power in the second embodiment. In cases illustrated in FIGS. 7A and 7B, the ratio between the transmission power of the information signal and the transmission power of the energy signal transmitted from the base station 10 is “10:90”. Here, when a charging rate of the battery 32c is low, it is preferable that the terminal device 30 increase the distribution rate to the energy receiver 32. In FIG. 7A, the distribution rate to the energy receiver 32 by the splitter 31 is 90 percents. In this case, the power used to charge the battery 32c is 81 percents of the total power of the received signal. On the other hand, when the charging rate of the battery 32c is high, it is preferable that the terminal device 30 set the distribution rate to the energy receiver 32 to be low. In FIG. 7B, the distribution rate to the energy receiver 32 by the splitter 31 is 10 percents. In this case, the power used to charge the battery 32c is nine percents of the total power of the received signal.

In this way, when the charging rate of the battery 32c is low, by increasing the distribution rate to the energy receiver 32, most of the power of the received signal is used to charge the battery 32c. For example, efficient power supply is realized. On the other hand, in the case illustrated in FIG. 7B, 80 percents or more of the total power of the received signal is not used. As a result, although the distribution rate to the energy receiver 32 is low, sufficient power is not distributed to the information receiver 33. Here, when the power of the signal guided to the information receiver 33 is low, the error rate increases due to deterioration in a signal-to-noise ratio. Therefore, a transmission rate is lowered. For example, when the error rate is high, it is necessary to reduce the number of bits to be transmitted in one symbol and/or to lower a baud rate. Therefore, the transmission rate is lowered. For example, in the case illustrated in FIG. 7B, an efficiency of information communication is lowered.

In cases illustrated in FIGS. 7C and 7D, the ratio between the transmission power of the information signal and the transmission power of the energy signal transmitted from the base station 10 is “90:10”. Here, when the charging rate of the battery 32c is high, it is preferable that the terminal device 30 increase the distribution rate to the information receiver 33. In FIG. 7C, the distribution rate to the information receiver 33 by the splitter 31 is 90 percents. In this case, the power used for the wireless communication is 81 percents of the total power of the received signal. As a result, since the error rate is lowered, the transmission rate can be increased. For example, in the case illustrated in FIG. 7C, the efficiency of the information communication increases.

On the other hand, when the charging rate of the battery 32c is low, it is preferable that the terminal device 30 increase the distribution rate to the energy receiver 32. In FIG. 7D, the distribution rate to the energy receiver 32 by the splitter 31 is 90 percents. However, in this case, the power used to charge the battery 32c is nine percents of the total power of the received signal. For example, although the distribution rate to the energy receiver 32 by the splitter 31 is high, a power supply efficiency is low.

In this way, only by controlling the distribution rate of the splitter 31, there is a case where it is not possible to adjust both of the power supply efficiency and the communication efficiency in a balanced manner. Therefore, in the embodiment, by appropriately controlling the ratio of the transmission power between the information signal and the energy signal and the distribution rate of the power to the energy receiver 32 and the information receiver 33, both of the power supply efficiency and the communication efficiency are adjusted in a balanced manner.

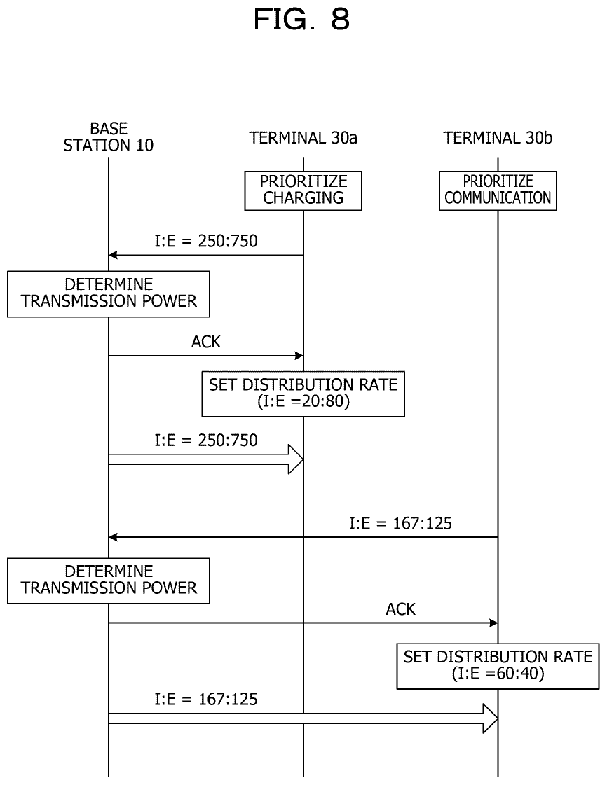

FIG. 8 illustrates an example of a power supply sequence according to the second embodiment. In this example, two terminal devices (30a and 30b) are coupled to the base station 10. A configuration of each of the terminal devices 30a and 30b is the same as that of the terminal device 30 illustrated in FIG. 6.

It is assumed that the charging rate of the battery 32c be low in the terminal device 30a. In this case, the control unit 34 determines the control information, the transmission power of the energy signal, and the distribution rate of the splitter 31, so that power as large as possible is distributed to the energy receiver 32. At this time, the ratio between the transmission power of the information signal and the transmission power of the energy signal (hereinafter, transmission power ratio) may be determined, instead of determining the control information and the transmission power of the energy signal. However, in order to maintain a predetermined transmission rate, it is necessary to set the power of the signal guided to the information receiver 33 to be equal to or more than a predetermined threshold level.

Here, it is assumed that the transmission power and the distribution rate of the splitter 31 be calculated so as to satisfy the following conditions. Note that, here, numerical values indicating transmission power and reception power are virtual values for simplification of the description, and in addition, it is assumed that there be no attenuation between the base station 10 and the terminal device 30.

(a) A maximum value of the transmission power of the base station 10 is “1000”.

(b) When the power of the signal guided to the information receiver 33 is equal to or more than “50”, the predetermined transmission rate can be maintained.

In this case, in order to shorten a charging time of the battery 32c, the transmission power and the distribution rate of the splitter 31 are determined so as to satisfy the following conditions.

(1) A sum of the transmission power of the information signal and the transmission power of the energy signal is the maximum transmission power of the base station 10 (for example, “1000”).

(2) The power of the signal guided to the information receiver 33 is “50”.

(3) The power of the signal guided to the energy receiver 32 is maximized.

For example, it is assumed that the distribution rate of the splitter 31 be “I (ratio of power to be distributed to information receiver 33):E (ratio of power to be distributed to energy receiver 32)=50:50”. In this case, in order to satisfy the condition (2), the transmission power of the information signal is set to “100”. Then, according to the condition (1), the transmission power of the energy signal is “900”. Furthermore, the power of the signal guided to the energy receiver 32 is “450”.

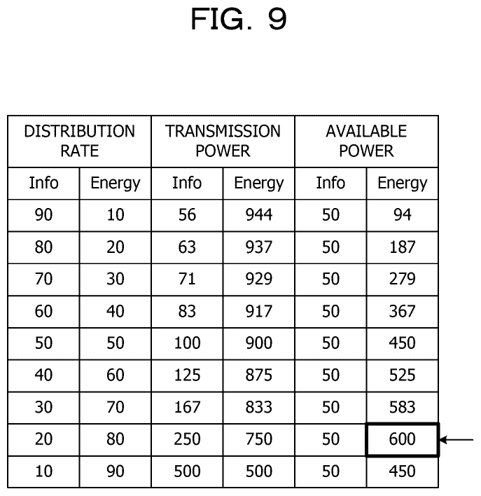

FIG. 9 illustrates a relationship between the distribution rate of the splitter 31 and the transmission power, calculated to satisfy the conditions (1) and (2). Here, according to the condition (3), a combination that maximizes the power of the signal guided to the energy receiver 32 is selected. In this example, when the distribution rate of the splitter 31 is “I:E=20:80” and the transmission power is “I (transmission power of information signal):E (transmission power of energy signal)=250:750”, the power of the signal guided to the energy receiver 32 is maximized.

The control unit 34 generates control information for instructing the transmission power of the information signal and the energy signal, based on the above calculation. For example, control information “I:E=250:750” is generated. Alternatively, when a total power when the base station 10 transmits a radio signal to the terminal device 30a is determined, the control unit 34 may generate control information indicating the ratio between the transmission power of the information signal and the transmission power of the energy signal. In this case, control information “I:E=25:75” is generated. Then, the terminal device 30a transmits this control information to the base station 10.

The base station 10 determines whether or not the transmission power can be set according to the control information. Then, when the transmission power of the information signal and the energy signal can be set according to the control information, the base station 10 transmits an ACK signal to the terminal device 30a. The ACK signal may be realized by returning the control information received from the terminal device 30a, to the terminal device 30a.

When receiving the ACK signal from the base station 10, the terminal device 30a sets the splitter 31 according to the distribution rate determined in advance. In this example, the splitter 31 is set so that the distribution rate is “I:E=20:80”.

Thereafter, the base station 10 transmits the information signal and the energy signal according to the control information received from the terminal device 30a. In this example, the base station 10 receives the control information “I:E=250:750”. Therefore, the base station 10 transmits the information signal with the transmission power “250” and transmits the energy signal with the transmission power “750”. Note that, when receiving the control information “I:E=25:75” indicating the ratio between the transmission power of the information signal and the transmission power of the energy signal, similarly, the base station 10 can transmit the information signal with the transmission power “250” and transmit the energy signal with the transmission power “750”. However, it is assumed that the maximum transmission power of the base station 10 be “1000”.

In the terminal device 30a, the splitter 31 branches the received signal and guides the received signal to the energy receiver 32 and the information receiver 33. Here, as described above, the distribution rate of the splitter 31 is set by the control unit 34. Therefore, 80 percents of the total power of the received signal is distributed to the energy receiver 32, and 20 percents of the total power of the received signal is distributed to the information receiver 33. As a result, in the terminal device 30a, it is possible to charge the battery 32c with a high power supply efficiency, while maintaining the transmission rate between the base station 10 and the terminal device 30a.

In the terminal device 30b, it is assumed that the battery 32c be sufficiently charged. Furthermore, it is assumed that the terminal device 30b desire to receive a large volume of data. In this case, the control unit 34 of the terminal device 30b increases the power distributed to the information receiver 33 according to the desired transmission rate, while suppressing the power distributed to the energy receiver 32 to the minimum necessary.

As an example, the transmission power and the distribution rate of the splitter 31 are determined so as to satisfy the following conditions.
(1) The power distributed to the energy receiver 32 is “50”.
(2) The power distributed to the information receiver 33 is “100”.
(3) The transmission power of the base station 10 is minimized.

For example, it is assumed that the distribution rate of the splitter 31 be “I:E=50:50”. In this case, in order to satisfy the condition (1), the transmission power of the energy signal is set to “100”. Furthermore, in order to satisfy the condition (2), the transmission power of the information signal is set to “200”.

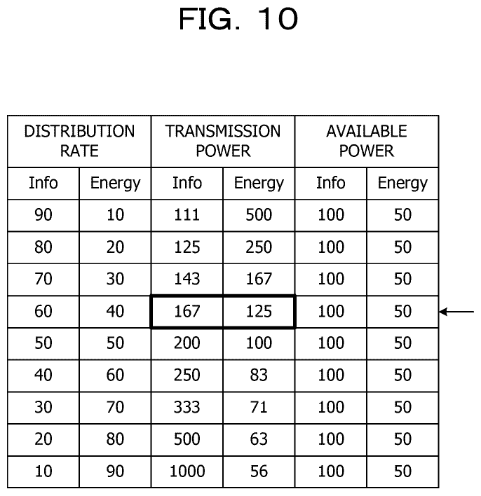

FIG. 10 illustrates a relationship between the distribution rate of the splitter 31 and the transmission power, calculated to satisfy the conditions (1) and (2). Here, according to the condition (3), a combination that minimizes the sum of the transmission power of the information signal and the transmission power of the energy signal is selected. In this example, when the distribution rate of the splitter 31 is “I:E=60:40” and the transmission power is “I:E=167:125”, the transmission power of the base station 10 is minimized.

The control unit 34 creates control information for instructing the transmission power of the information signal and the energy signal, based on the above calculation. In this example, the control information “I:E=167:125” is created and transmitted to the base station 10.

The base station 10 determines whether or not the information signal and the energy signal can be transmitted according to the control information. Then, when the information signal and the energy signal can be transmitted according to the control information, the base station 10 transmits the ACK signal to the terminal device 30b.

When receiving the ACK signal from the base station 10, the terminal device 30a sets the splitter 31 according to the distribution rate determined in advance. In this example, the splitter 31 is set so that the distribution rate is “I:E=60:40”.

Thereafter, the base station 10 transmits the information signal and the energy signal according to the control information received from the terminal device 30b. In this example, the base station 10 transmits the information signal with the transmission power “167” and transmits the energy signal with the transmission power “125”.

In the terminal device 30b, the splitter 31 branches the received signal and guides the received signal to the energy receiver 32 and the information receiver 33. At this time, 40 percents of the total power of the received signal is distributed to the energy receiver 32, and 60 percents of the total power of the received signal is distributed to the information receiver 33. As a result, efficient wireless communication and wireless power supply are realized, while suppressing the transmission power of the base station 10.

Note that, when it is not possible to receive the ACK signal from the base station 10, the terminal device 30 changes the distribution rate of the splitter 31 and determines a combination of transmission power corresponding to a new distribution rate. Then, the terminal device 30 notifies the base station 10 of the new combination of the transmission power, and the base station 10 determines whether or not it is possible to realize the new combination of the transmission power. A determination result is transmitted from the base station 10 to the terminal device 30. This procedure is repeatedly executed until the ACK signal is transmitted from the base station 10 to the terminal device 30.

In this way, according to the second embodiment, when the charging rate of the battery of the terminal device 30 is low, the transmission power of the information signal and the energy signal and the distribution rate of the splitter 31 are set, so that the power used to charge the battery increases, while maintaining the predetermined transmission rate. Therefore, the efficient wireless power supply can be realized, while maintaining the predetermined transmission rate. Furthermore, when the charging rate of the battery of the terminal device 30 is high, the transmission power of the base station 10 can be suppressed, while continuing the necessary minimum power supply and realizing a desired transmission rate.

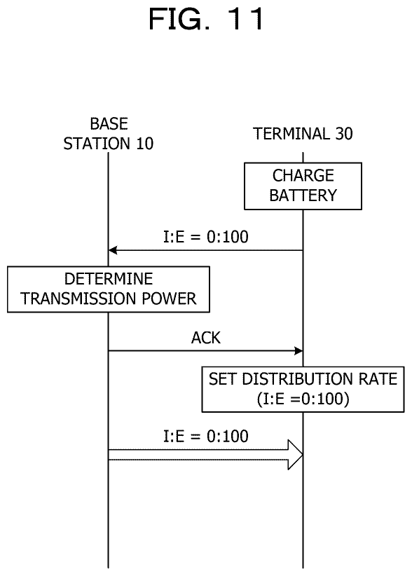

FIG. 11 illustrates a first variation of the second embodiment. In this example, the terminal device 30 is coupled to the base station 10.

The terminal device 30 may receive only the energy signal without receiving the information signal, in order to charge the battery 32c as quickly as possible. In this case, the terminal device 30 transmits control information “I:E=0:100” indicating the ratio between the transmission power of the information signal and the transmission power of the energy signal, to the base station 10.

Upon receiving this control information, the base station 10 determines whether or not requested transmission power can be realized. Then, when the requested transmission power can be realized, the base station 10 transmits the ACK signal to the terminal device 30. Upon receiving the ACK signal, the terminal device 30 controls the splitter 31 so that all power of the received signal is distributed to the energy receiver 32.

Thereafter, the base station 10 transmits the energy signal to the terminal device 30. At this time, the base station 10 does not need to transmit the information signal. Furthermore, the power of the energy signal may be predetermined maximum power. Then, the terminal device 30 guides this energy signal to the energy receiver 32. The energy receiver 32 charges the battery 32c with the power of the receiver energy signal. As a result, efficient rapid charging is realized.

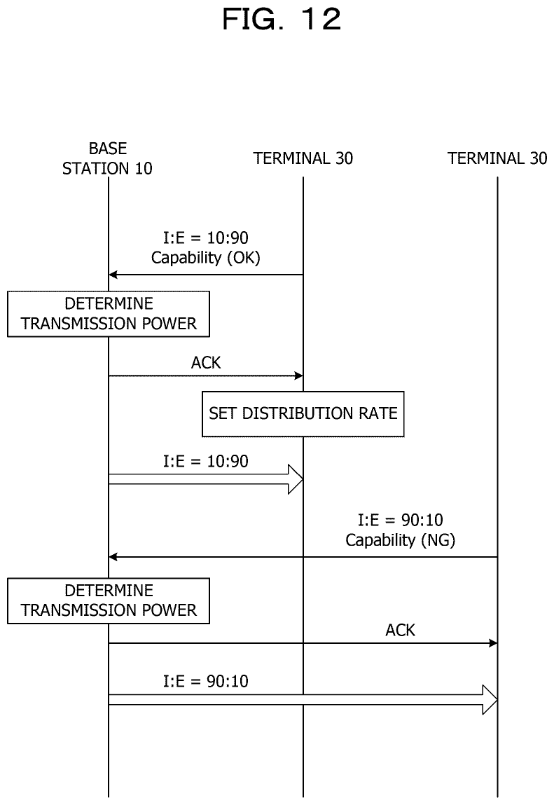

FIG. 12 illustrates a second variation of the second embodiment. In the second variation, the terminal device 30 transmits Capability information indicating a capability of the terminal device 30 to the base station 10, in addition to the control information. The Capability information indicates, for example, whether or not the distribution rate of the splitter 31 can be changed.

As in the cases illustrated in FIGS. 8 to 10, the base station 10 determines whether or not the transmission power requested from the terminal device 30 can be realized. Then, when the transmission power requested from the terminal device 30 can be realized, the base station 10 transmits the ACK signal to the terminal device 30. On the other hand, when it is not possible to realize the transmission power requested from the terminal device 30, the base station 10 refers to the Capability information. Here, when the Capability information is “OK: distribution rate can be changed”, the base station 10 may transmit a NACK signal indicating that it is not possible to realize the requested transmission power to the terminal device 30 and request the terminal device 30 to change the distribution rate of the splitter 31. Note that, when the Capability information is “NG: it is not possible to change distribution rate”, the base station 10 simply transmits the NACK signal to the terminal device 30.

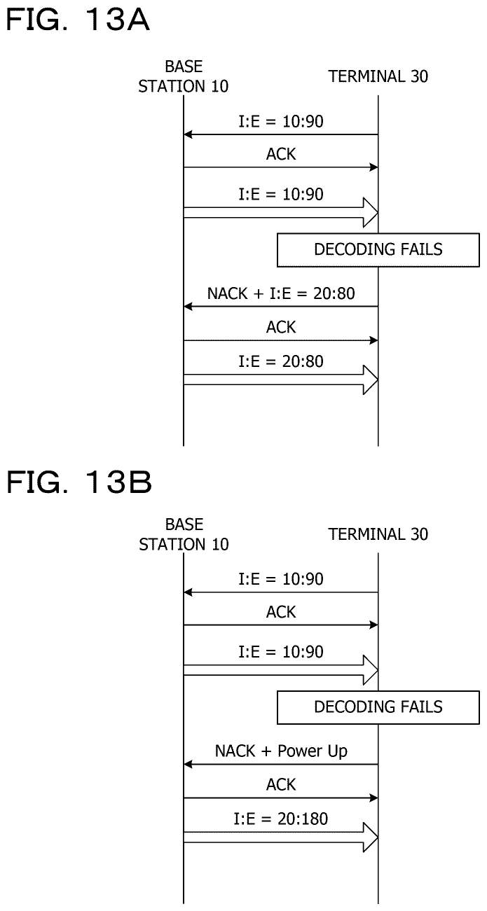

FIGS. 13A and 13B illustrate a third variation of the second embodiment. The third variation includes a procedure for changing the transmission power of the base station 10 when decoding of the information signal fails. For example, in the case illustrated in FIG. 13A, the power of the information signal and the power of the energy signal transmitted from the base station 10 are respectively “10” and “90”. For example, the transmission power of the information signal is small. As a result, when decoding of the information signal fails, the terminal device 30 transmits a NACK signal indicating a failure of decoding to the base station 10. Furthermore, the terminal device 30 transmits control information for requesting to change the ratio between the transmission power of the information signal and the transmission power of the energy information to the base station 10. This control information requests, for example, to increase the power of the information signal and decrease the power of the energy signal. Then, the base station 10 controls the transmission power according to this control information. As a result, the power of the information signal and the power of the energy signal transmitted from the base station 10 to the terminal device 30 are respectively changed to “20” and “80”.

In the example illustrated in FIG. 13B, when decoding of the information signal fails, the terminal device 30 transmits the NACK signal and control information for requesting to increase the transmission power to the base station 10. This control information requests to increase each of the power of the information signal and the power of the energy signal. Then, the base station 10 controls the transmission power according to the control information. In this example, the power of the information signal and the power of the energy signal transmitted from the base station 10 to the terminal device 30 are respectively changed to “20” and “180”.

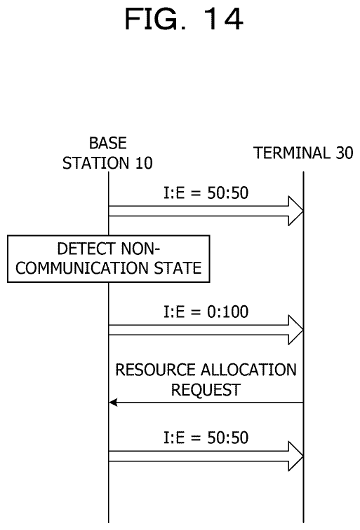

FIG. 14 illustrates a fourth variation of the second embodiment. In the fourth variation, the base station 10 monitors a state of the wireless communication with the terminal device 30. As an example, when the base station 10 does not receive a resource allocation request from the terminal device 30 continuously for a predetermined time or more, the base station 10 determines that the terminal device 30 is in a non-communication state. The resource allocation request is a signal that requests a resource used for the communication between the base station 10 and the terminal device 30 and is transmitted from the terminal device 30 to the base station 10. Then, when detecting a state where the terminal device 30 is in the non-communication state, the base station 10 stops the information signal and transmits only the energy signal to the terminal device 30. As a result, the terminal device 30 that does not perform wireless communication can efficiently charge the battery 32c using this energy signal. In addition, power consumption of the base station 10 can be reduced.

Thereafter, when starting the wireless communication, the terminal device 30 transmits the resource allocation request to the base station 10. The base station 10 allocates a resource to the terminal device 30 in response to the resource allocation request and controls the transmission power of the information signal and the energy signal. In this example, the power of the information signal and the power of the energy signal transmitted from the base station 10 are respectively set to “50” and “50”.

Note that, in the above example, the splitter 31 generates a first received signal guided to the energy receiver 32 and a second received signal guided to the information receiver 33, by branching the received signal. Here, the splitter 31 is a power splitter, and content of the first received signal and content of the second received signal are the same as each other. However, when the information signal and the energy signal are simultaneously transmitted by the frequency division multiplexing, the splitter 31 may extract a frequency component of the information signal from the received signal and guide the frequency component to the information receiver 33 and extract a frequency component of the energy signal from the received signal and guide the frequency component to the energy receiver 32.

### Third Embodiment

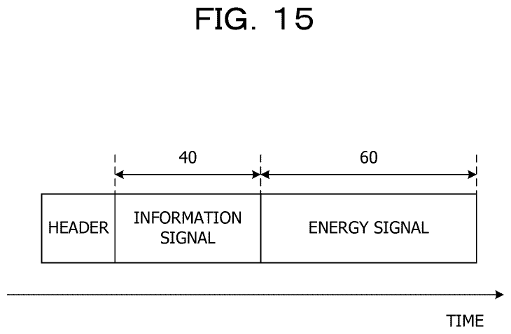

In a third embodiment, an information signal and an energy signal are simultaneously transmitted by a time division multiplexing method. In this case, a base station 10 transmits, for example, a frame illustrated in FIG. 15 to a terminal device 30. The frame includes a header and a payload. In the payload, the information signal and the energy signal are stored.

The base station 10 sets a length of the information signal and a length of the energy signal in the payload, based on control information transmitted from the terminal device 30. For example, when the control information received from the terminal device 30 is “I:E=40:60”, a frame is configured so that a ratio between the length of the information signal and the length of the energy signal is “40:60”.

The terminal device 30 receives the frame transmitted from the base station 10. Here, it is assumed that the terminal device 30 can detect a head of each frame. Furthermore, since the payload is created in the base station 10 according to the control information transmitted from the terminal device 30 to the base station 10, the terminal device 30 can recognize a time band when the information signal and the energy signal are received. Therefore, by controlling a splitter 31, the terminal device 30 can guide the information signal to the information receiver 33 and guide the energy signal to the energy receiver 32. Note that, in the third embodiment, the terminal device 30 may include a selector that selectively guides the received signal to the information receiver 33 or the energy receiver 32, as the splitter 31.

In the wireless communication system having the configuration described above, when a charging rate of a battery 32c is low, the terminal device 30 transmits control information for requesting a short information signal and a long energy signal, to the base station 10. As a result, an efficiency of wireless power supply is improved. On the other hand, when the charging rate of the battery 32c is high, the terminal device 30 transmits control information for requesting a long information signal and a short energy signal, to the base station 10. As a result, transmission data can be increased. Note that the control information transmitted from the terminal device 30 to the base station 10 may include a desired value of transmission power, in addition to the information indicating the ratio between the length of the information signal and the length of the energy signal.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wireless communication system comprising: a first wireless communication device; and a second wireless communication device, wherein
the first wireless communication device includes
a transmission circuit that transmits an information signal and an energy signal, and
a first processor that controls transmission of the information signal and the energy signal,
the second wireless communication device includes
a splitter that branches a received signal from the first wireless communication device and generates a first received signal and a second received signal,
an energy receiver that rectifies the energy signal included in the first received signal and generates a direct current,
an information receiver that decodes the information signal included in the second received signal, and
a second processor that generates control information that includes a request related to transmission power of the information signal and transmission power of the energy signal,
the second wireless communication device transmits the control information to the first wireless communication device, and
in the first wireless communication device, the first processor controls the transmission power of the information signal and the transmission power of the energy signal based on the control information.

2. The wireless communication system according to claim 1, wherein
the control information includes information that indicates a ratio between the transmission power of the information signal and the transmission power of the energy signal.

3. The wireless communication system according to claim 1, wherein
the control information includes information that indicates a desired value of the transmission power of the information signal and a desired value of the transmission power of the energy signal.

4. The wireless communication system according to claim 1, wherein
the second processor
sets a desired value of power of the information signal included in the second received signal guided to the information receiver,
calculates the transmission power of the information signal, the transmission power of the energy signal, and a distribution rate that indicates a ratio between power of the first received signal and power of the second received signal, so as to satisfy the desired value and maximize power of the energy signal included in the first received signal guided to the energy receiver,
transmits the control information that includes information that indicates the transmission power of the information signal and the energy signal to the first wireless communication device, and
sets the splitter so that the received signal is branched according to the distribution rate.

5. The wireless communication system according to claim 1, wherein
when decoding of the information signal fails in the information receiver, the second wireless communication device transmits control information that increases the ratio of the transmission power of the information signal with respect to the transmission power of the energy signal to the first wireless communication device.

6. The wireless communication system according to claim 1, wherein
when decoding of the information signal fails in the information receiver, the second wireless communication device transmits control information that increases the transmission power of the information signal and the energy signal to the first wireless communication device.

7. The wireless communication system according to claim 1, wherein
when detecting that the second wireless communication device is in a non-communication state, the first wireless communication device stops the transmission of the information signal and transmits only the energy signal to the second wireless communication device.

8. The wireless communication system according to claim 1, wherein
the transmission circuit simultaneously transmits the information signal and the energy signal to the second wireless communication device by frequency division multiplexing.

9. The wireless communication system according to claim 1, wherein
the transmission circuit simultaneously transmits the information signal and the energy signal to the second wireless communication device by time division multiplexing.

10. A wireless communication method for transmitting power from a first wireless communication device to a second wireless communication device using a wireless signal, wherein
the first wireless communication device includes
a transmission circuit that transmits an information signal and an energy signal, and
the second wireless communication device includes
a splitter that branches a received signal from the first wireless communication device and generates a first received signal and a second received signal,
an energy receiver that rectifies the energy signal included in the first received signal and generates a direct current,
an information receiver that decodes the information signal included in the second received signal, and
the second wireless communication device transmits control information that includes a request related to transmission power of the information signal and transmission power of the energy signal to the first wireless communication device, and
the first wireless communication device controls the transmission power of the information signal and the transmission power of the energy signal based on the control information.
